(19) United States
(12) Patent Application Publication
(10) Pub. No.: US 2002/0125590 A1
(43) Pub. Date: Sep. 12, 2002

(54) Production method for producing granulated materials by controlling particle size distribution using diffracted and/or scattered light from growing particles under granulation and apparatus for executing the same

(76) Inventors: Yasushi Watanabe, Numazu-city (JP); Kiyoshi Morimoto, Mishima-city (JP); Satoru Hiruta, Sunto-gun (JP); Hideyuki Ikeda, Nishikyo-ku (JP)

Correspondence Address: JONES, TULLAR & COPPER, P.C., Eads Station, P.O. Box 2266, Arlington, VA, 22202, US

(21) Appl. No.: 10/079,827

(22) Filed: Feb. 22, 2002

Related U.S. Application Data
(63) Continuation-in-part of application No. 09/179,887, filed on Oct. 28, 1998, now abandoned.

(30) Foreign Application Priority Data
Oct. 30, 1997 (JP) 9-298618

(51) Int. Cl. B29B 9/00

(52) U.S. Cl. 264/5; 23/313 FB; 264/11; 264/12; 264/40.1; 425/135

(57) ABSTRACT

A production method for producing granulated materials comprises sampling step for sampling at predetermined time intervals diffracted and/or scattered light from growing particles under granulation in a granulation tank as measured particle size distribution data by applying beam light to the growing particles, calculating step for calculating the size of particle from the measured particle size distribution data by applying a specific algorithm, comparison step for comparing the particle size from the measured particle size distribution data with that from the particle size distribution objective data prepared in advance, and correction step for adding change to basic feedback control for granulation process in accordance with the result of the comparison step. And the granulated materials production apparatus comprises a granulation tank therein having a fluid bed and spray means for spraying a binder solution above the fluid bed, and sampling measurement apparatus detachable to the corresponding portion of the granulation tank, into which growing particles floating in the granulation tank are introduced for sampling.

### BACKGROUND OF THE INVENTION

1. Field of the Invention

The present invention relates to a production method and apparatus for producing granulated materials which is capable of controlling particle size distribution of the granulated materials using diffracted and/or scattered light phenomenon, and more particularly relates to a production method and apparatus for repeatedly and efficiently producing granulated materials by way of batch process with no dispersions and with same particle size distributions.

2. Prior Art

In the pharmaceutical field, many kinds of medicine made from powdered materials have been developed up to now. A production method for manufacturing granulated materials with desired sizes has been also developed in order to improve the difficulties such as adhesion or dustability problem due to the smallness of the particles.

A fluid bed granulation system has been well known and widely used in the field of pharmaceutical and food industry and now one example of a prior art will be given hereinafter.

In such fluid bed granulation system, raw powdered materials are fluidized by being mixed with heated air, aggregated each other by being spraying a binder solution from a nozzle, then dried to produce granulated materials with fixed sizes. This system has such advantage that mixing, granulation, drying, coating and other process can be executed by the same machine and particle size, density and shape of the granulated materials can be optionally controlled and further that it is possible to reduce the production steps necessary for granulation, to save spacing and to prevent contamination.

FIG. 22 shows a granulation apparatus with fluid bed and a measurement apparatus of growing particles in the prior art.

A granulation apparatus 100 comprises a granulation tank 109, a fluid bed 102, a camera means (photo taking means) 103, a controller 104 for the camera means 103, and an arithmetic means 105 for processing the picture images taken by the camera means 103.

A heated air supply port 102h for supplying heated air into the tank 109 is provided at the lower part of the tank 109. A fluid bed 106 is provided above the heated air supply port 102h for temporarily placing powdered material thereon. And a nozzle 107 for spraying a binder solution is provided above the bed 106 in order to aggregate growing materials floating above the bed 106. In FIG. 22, the numeral 108 refers to a bag filter.

According to the granulation apparatus shown in FIG. 22, in the event of granulation, firstly raw powdered materials are placed on the fluid bed 106 then a binder solution is sprayed from a nozzle 107 to aggregate raw powdered materials floating above the bed 106 while heated air is supplied into the tank 109 to fluidize and mix the raw powdered materials with heated air, thereby producing granulated materials with specific size.

FIG. 23 shows a schematic sectional viewof the camera means 103 according to the prior art. The camera means 103 is provided with a cylindrical scope body 131, a CCD camera 132, a lens scope 133 connected to CCD camera 132, and a light guide 134. The CCD camera 132, the lens scope 133, and the light guide 134 are all contained in the scope body 131. Further, a supply port 131a and a discharge port 131b for purge air are both provided in the scope body 131.

An optical fiber cable 135 is connected to the light guide 134 so that a stroboscope light transmitted from light source (not shown) is emitted at the front of a stroboscopic illuminant 134a via the optical fiber cable 135.

And the stroboscopic illuminant 134a emits light at fixed time intervals so that the CCD camera 132 takes a picture of growing particles under granulation in front of the lens scope 133 during the stroboscopic illuminant 134a emits light.

According to thus constructed system, growing particles floating above the fluid bed 102 are taken their pictures by the CCD camera 132 in time series and are sequentially changed into binary picture. And thereafter, some overlapped images in binary pictures are separated each other by executing the algorithm such as circular or a wedge separate method and finally the images of the growing particles are independently extracted in binary pictures as shown in FIGS. 24(a)-24(h).

In this system, growing particles floating above the fluid bed 102 are recognized as a still binary picture and granulation process is performed while observing the images of the growing particle images represented in binary picture and finished when the growing particles grow up to an granulated materials with the particle sizes previously set-up.

However, according to the system 101 as mentioned above, a picture taking area R1 is limited toward the front of the lens scope 133 with its focal depth set short distance, and further a picture taking face R2 is very small as shown in FIG. 25.

Therefore, the number of the images of particles taken by CCD camera 132 would become decrease as the particles grow up and further they would more decrease when granulation procedure nears to an end.

As a result, the images of particles thus taken by the CCD camera 132 would not truly represent the condition of the particles under granulation in the tank 109.

Further, in such system 101, although materials to be granulated in the tank 109 is generally controlled in their average particle sizes by executing feedback control of its performing time, temperature of heated air, the amount of binder solution by injection spray for specific granulation process, however for their particle size distribution it is not controlled at all.

As a result, comparing granulated materials independently produced, they include particles of large sizes or particles of little sizes so many in numbers, therefore dispersion in particle size distribution are much founded in each lot even if the granulated materials with the same particle distribution a retried to be produced, with the result that dispersion in their physical properties would occur for produced tablets, capsules or granules.

Consequently, there occur several problems in producing granulated materials such as medicine tablets and granules as follows.

Namely when producing medicine tablets, for example for such tables that include many particles with smaller sizes, the produced tablets so produced will become heavier than expected in their weight, and for such tables that include many particles with larger sizes, tablets so producedwill become lighter than expected in their weight. Further for such tables as to have broad particle size distribution, there occurs non-uniform in each content of main ingredient different in particle size distribution and in their hardness of the tablets to be produced.

Further in case that medicine granules are produced, when their particle size distribution being broad, there occurs dispersion in the weight of medicine granules contained in each package or each bottle when the same capacity of medicine granules are separately packed or bottled, and they would become inadequate in the product standard of particle size distribution when the degree of those is terrible.

As mentioned above, in such prior system, particle size distribution of the granulated materials are not controlled at all nevertheless their particle size distributions are most important.

As a result, it would be possible to occur dispersion in the weight, or the hardness of produced medicine tablets.

### SUMMARY OF THE INVENTION

The present invention is proposed in order to solve the above-mentioned problems.

Accordingly, a primary object of the invention is to provide a production method in which a basic feedback control for granulation process is corrected by controlling growing factor of the particles under granulation, such as temperature of heated air, flow amount of heated air, or injection amount of a binder solution during the granulation process is performed, every time diffracted and/or scattered light from the growing particles under granulation in granulation tank is sampled, for producing granulated materials with desired particle sizes distribution.

The secondary object of the invention is to provide a granulated materials production apparatus capable of efficiently and repeatedly producing granulated materials with desired particle sizes distribution.

Other and further objects, features and advantages of the invention will appear more fully from the following description.

Accordingly, in order to achieve above-mentioned objects, inventors propose following method and apparatus as the present inventions.

Namely, a production method for producing granulated materials according to the present invention, comprises the steps of; sampling at predetermined time intervals diffracted and/or scattered light from growing particles under granulation in said granulation tank by applying beam light to said growing particles to take out them as measured particle size distribution data, calculating the size of particle from said measured particle size distribution data by applying a specified algorithm, comparing said size of particle calculated from said measured particle size distribution data with the size of particle calculated from particle size distribution objective data prepared in advance, and correcting said basic feedback control by controlling said particle growing factor such as temperature of heated air, flow amount of heated air, or injection amount of a binder solution in accordance with the result at said comparison step.

Here, diffracted and/or scattered light is defined as such meaning to include diffracted light and scattered light, therefore either of them can be used for the present invention.

Concerning beam light, it is desirable to use coherent laser beams with short waves and equal phases, in case that such leaser beams are used more smaller particles will be well distinguished and particle size distribution will be able to be analyzed more precisely.

The particle size distribution objective data used in the present invention for comparison are defined as time series data of particle size distribution data obtained in advance by sampling diffracted and/or scattered light from growing particles under granulation in a granulation tank by applying beam light to the growing particles like as the measured particle size distribution data to be obtained at sampling step.

Therefore, the sampling time interval for said particle size distribution objective data is the same as that for particle size distribution data to be obtained at said sampling step and the amount of the raw materials for said particle size distribution objective data is also the same as that for said raw materials to be granulated in said granulation tank.

And in the present invention, at said comparison step, the size of particle calculated from said measured particle size distribution data is compared with that calculated from corresponding particle size distribution objective data in time series, and at said correction step, said basic feedback control is corrected by controlling said particle growing factor so as to promote the growth of said particles in said granulation tank when said size of particle calculated from said measured particle size distribution data is smaller than that calculated from corresponding particle size distribution objective data in time series, whereas said basic feedback control is corrected by controlling said particle growing factor so as to stop or hinder the growth of said particles in said granulation tank when said size of particle calculated from said measured particle size distribution data is larger than that calculated from corresponding particle size distribution objective data in time series.

To obtain particle size distribution data from sampled diffracted and/or scattered light form the particles is supported by photo scattering analysis on particles such as The Mie Scatter Theory.

According to The Mie Scatter Theory, sideward scattering, and backward scattering increase than frontward scattering as the particle sizes are smaller, for the particles whose diameter is larger than 0.56 μm, the intensity value of frontward scattering whose scattering angle is small largely changes, thereby enabling to discriminate by only detecting of frontward scattering, while when the particle diameter has become less than 0.1 μm, the intensity value of frontward scattering whose scattering angle is small changes a little and the intensity value of sideward, backward scattering whose scattering angle is small largely changes. And for discriminating small particle sizes, a light source such as He-Ne laser, tungsten lamp, of which wave length s are short is preferably used. In the present invention, the particle sizes are calculated from the sampled diffracted and/or scattered light form growing particles under granulation in a granulation tank, and in that case various statistics values can be used. At the comparison step, as such particle size as to be compared with that of calculated from the corresponding objective data in time series, median diameter, 20% particle diameter, 80% particle diameter, peak diameter, and the average diameter or the like may be equivalently used.

As to the growing factors for correcting a basic feedback control for batch granulation process, temperature of heated air, flow volume of heated air, or amount of binder solution per time or the like are used as used in basic feedback control for batch granulation process. According to such method of the present invention using diffracted and/or scattered light from particles, there is no problem of decreasing the images of particles in number as the particles grow and it will be possible to grasp particle size distribution of growing particles more precisely during granulation process is performed, even if the numbers of the particles decrease as the granulation process draws to a close.

Accordingly, according to the present invention, since particle size distribution data show appropriately the condition of growing particles under granulation in a granulation tank all the time during the granulation batch process is performed, it can be easily and repeatedly produce such granulated materials with the equal average particle sizes and particle size distributions.

In the preferred first embodiment of the present invention, sampling step of diffracted and/or scattered light from growing particles under granulation in granulation tank is executed in a sampling measurement apparatus communicating with the granulation tank through an introduction conduit, where a part of groups of growing particles floating in the granulation tank are introduced by suction into a measurement cell provided in the sampling measurement apparatus, and beam light is applied to the growing particles form a light projection means, while diffracted and/or scattered light from the growing particles is received into a light detection means opposite to the light projection means.

In the preferred second embodiment, sampling step of diffracted and/or scattered light from growing particles under granulation in granulation tank is executed in a sampling measurement probe attached to a granulation tank, a part of groups of growing particles floating in the granulation tank enter a measurement chamber, and beam light is applied to the growing particles forma light projection means, while diffracted and/or scattered light from the growing particles is received into a light detection means opposite to the light projection means.

The granulated materials production apparatus for realizing the present method is also proposed, wherein the granulation apparatus comprises therein a granulation tank having a fluid bed and spraying means provided above said fluid bed for spraying a binder solution, and a sampling measurement apparatus detachable to said granulation tank.

The sampling measurement apparatus comprises an introduction conduit detachable to the corresponding portion of said granulation tank, a measurement cell provided midway of said conduit, and a suction means for introducing by suction a part of groups of growing particles under granulation in the granulation tank into said measurement cell.

According to such construction, a part of groups of growing particles under granulation in said granulation tank is introduced into the measurement cell by suction by driving the suction means and

beam light is applied to the growing particles form a light projection means, while diffracted and/or scattered light from the growing particles is received into the light detection means.

Moreover, according to such construction, since the sampling measurement apparatus is detachable to the corresponding portion of the granulation tank, the sampling measurement apparatus can be easily removed when not necessary, and it is easy to clean it when removed.

Further in preferable embodiment, sampling measurement apparatus comprises a upper cell part and a lower cell part, each having light transmission portions, and the end portion of said upper cell part is inserted into said lower cell part so as to form an overlapped portion, wherein purge gas is forcedly introduced into the gap between said upper cell portion and lower cell portion for preventing of adhering of said growing particles floating in said measurement cell and/or dust particles.

The granulated materials production apparatus of an alternative embodiment for realizing the present method is further proposed, wherein the apparatus comprises therein a granulating tank having a fluid bed and spraying means provided above said fluid bed for spraying a binder solution, and a sampling measurement probe detachable to said granulation tank.

The sampling measurement probe comprises a measurement chamber surrounded by light transmission windows, a light projection means disposed through said light transmission windows in one side to said measurement chamber, and a light detection means disposed opposite to said light projection means.

According to such construction, a part of groups of growing particles in said granulation tank enters said measurement chamber during said granulation tank is operated for performing granulation process and beam light is applied to said growing particles under granulation from said light projection means and diffraction and/or scattered light from said growing particles is received into said light detection means. Therefore it is not necessary to provide introduction means for introducing the growing particles floating in the granulation tank into the measurement cell.

Moreover, according to such construction, since the sampling measurement probe is detachable to the corresponding portion of the granulation tank, the probe can be easily removed when not necessary, and it is easy to clean it when removed.

Still further in first and second embodiment of the granulation apparatus according to the present invention, it is so constructed that purge gas is blown onto the surfaces of a pair of light transmission windows disposed with a fixed spacing, therefore it can be prevented a part of groups of growing particles and other dust particles from adhering to the surfaces of the light transmission windows.

According to such construction, since a pair of transmission windows can be kept clean by blowing purge air such as compressed air or inert gas onto the surface of the transmission windows all the time during the granulation process is performed, diffracted and/or scattered light from the growing particles will not be reduced or partly shut off by growing particles or dust particles adhered to their surfaces, therefore diffracted and/or scattered light from the growing particles can be appropriately received into the light detection means.

While the present invention has been particularly shown and described with reference to preferred embodiments thereof, it will be understood by those skilled in the art that the foregoing and other changes in form and details can be made therein without departing from the spirit and scope of the invention.

### BRIEF DESCRIPTION OF THE DRAWINGS

FIG. 1 shows a basic principle of the present invention and a construction of the operation unit.

FIG. 2 shows one preferable embodiment of a granulated materials production apparatus of the present invention.

FIG. 3 shows one embodiment of a sampling measurement apparatus.

FIG. 4 shows a basic construction of a diffracted and/or scattered light detecting system for the growing particles.

FIG. 5 is an external view showing a construction of a sampling measurement apparatus.

FIG. 6a shows a cross sectional view of the sampling measurement apparatus seen from its top and

FIG. 6b is a cross sectional view of the sampling measurement apparatus seen vertically.

FIG. 7 shows concept of particle size distribution objective data.

FIG. 8 shows concept of measured particle size distribution data.

FIG. 9 shows alternative embodiment of a granulated materials production apparatus of the present invention.

FIG. 10 shows a basic construction of a sampling measurement probe.

FIG. 11 shows a schematic diagram showing a basic construction of a ring detector.

FIG. 12a shows output of the ring detector (when raw material isn't stored in the granulation tank) and

FIG. 12b shows the particle size distribution data corresponding to FIG. 12a.

FIG. 13a shows output of the ring detector (under granulation) and

FIG. 13b shows the particle size distribution data corresponding to FIG. 13a.

FIG. 14a shows output of the ring detector (when granulation process comes near finish) and

FIG. 14b shows the particle size distribution data corresponding to FIG. 14a.

FIG. 15 shows the change of growing particles of granulated materials during granulation process is executed.

FIG. 16 shows the change of growing particles of granulated materials together with their allowable ranges.

FIG. 17 shows a basic feedback control of growing factor (flow amount of heated air).

FIG. 18 shows a basic feedback control of growing factor (spray amount of a binder solution)

FIG. 19 shows a basic feedback control of the growing factor (temperature of heated air).

FIG. 20 shows an example how the particle size of growing granulated materials is corrected by executing the present invention during basic feedback control is performed.

FIG. 21a shows a cross sectional view of alternative embodiment of a sample measurement apparatus seen from its top side and

FIG. 21b is a cross sectional view of the same seen vertically.

FIG. 22 shows a schematic diagram of a granulation apparatus with a fluid bed in the prior art.

FIG. 23 shows a schematic vertical section of imaging means in the prior art.

FIGS. 24a-24h show images of the growing particles arranged in time series order taken by the imaging means such as CCD camera.

### DESCRIPTION OF THE PREFERRED EMBODIMENTS

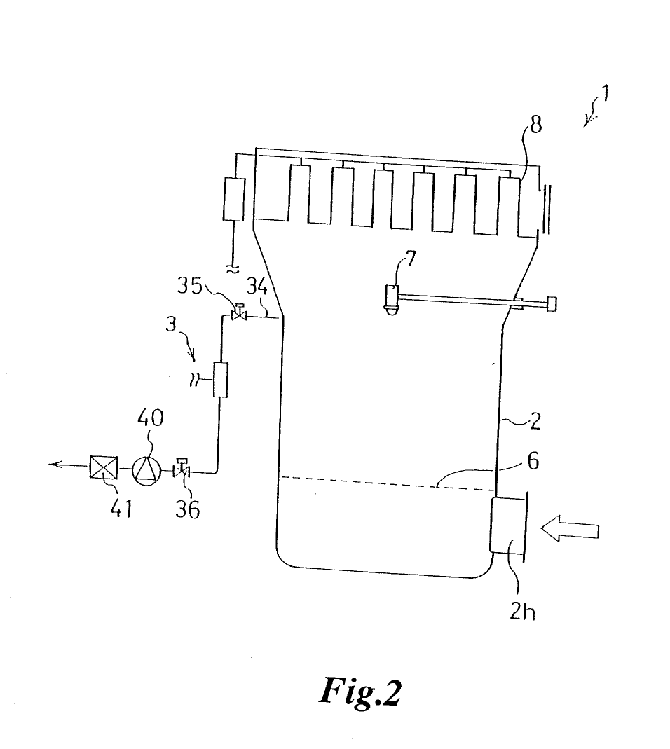

FIG. 2 shows one embodiment of a granulated materials production apparatus provided with a sampling measurement apparatus for preferably executing the production method of the present invention.

The apparatus 1 is provided with a granulation tank 2 and a sampling measurement apparatus 3 is detachably attached to the tank 2.

A heated air supply port 2h for supplying heated air into the granulation tank 2 is provided at the lower part thereof and a fluid bed 6 for temporarily placing powdered materials is provided above the heated air supply port 2h. A nozzle 7 for spraying a binder solution is provided within the upper part of the granulation tank 2.

In FIG. 2 the numeral 8 refers to a bag filter, 35 and 36 refer to valves for controlling supply of the particles floating in the granulation tank 2 into the measurement cell 31, 40 refers to a blower which serves a suction means and the numeral 41 refers to a dust collection filter.

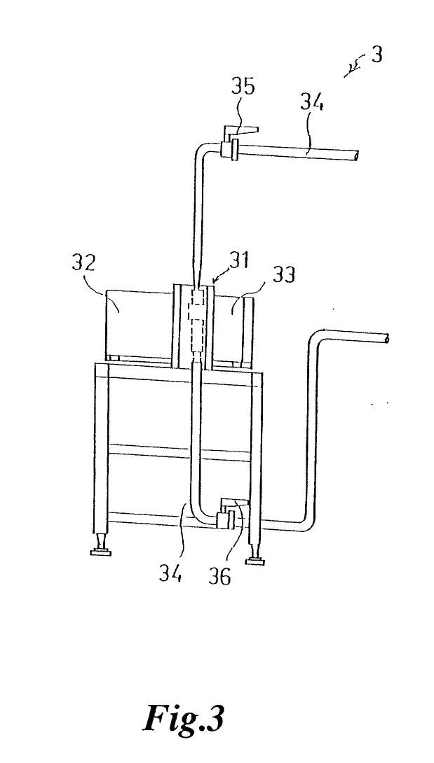

FIG. 3 schematically shows an external view of a sampling measurement apparatus 3.

The measurement apparatus 3 comprises a conduit 34 detachably connected to the corresponding portion of the granulation tank 2, a measurement cell 31 interposed in the conduit 34, a suction means 40 such as a blower provided at the terminal end of the conduit 34, a light projection means 32 for applying beam light to the measurement cell 31, and a light detector 33 disposed so as to face the light projection means 32 through the measurement cell 31.

The suction means 40 is so constructed as to introduce a part of groups of the growing particles floating above the fluid bed 6 into the measurement cell 31 via the conduit 34.

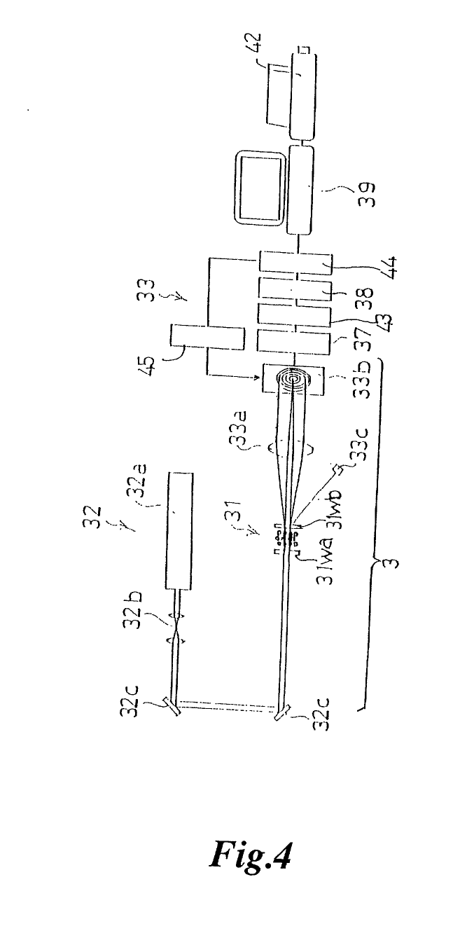

FIG. 4 is a schematic diagram showing a laser light projecting optical system and a diffracted and/or scattered light receiving optical system which may be used in the present invention.

The laser light projecting optical system comprises a light projection means 32 provided with a laser source 32a, a collimator 32b and a mirror 32c which may be provided when required.

The diffracted and/or scattered light receiving optical system comprises the light detector 33 which includes a condensing lens 33a for condensing the diffracted and/or scattered light from the particles in the measurement cell 31, a ring detector 33b (silicon detector, explained later) disposed on the focal face of the condensing lens 33a, and a sensor 33c for detecting the light scattered aside. The numerals 31Wa and 31Wb are light transmission windows and constitute the measurement cell 31.

The outputs from the ring detector 33b and the sensor 33c are inputted into an arithmetic means 39 via an amplifier 37 and an A/D converter 38, and the particle size distributions are calculated by applying a specified algorithm prepared in advance.

In the figure, the numeral 42 refers to a printer for printing several kinds of data processed in the arithmetic means 39. The numeral 43 refers to a sample hold circuit, 44 refers to a data transfer, and 45 refers to an automatic focus controller.

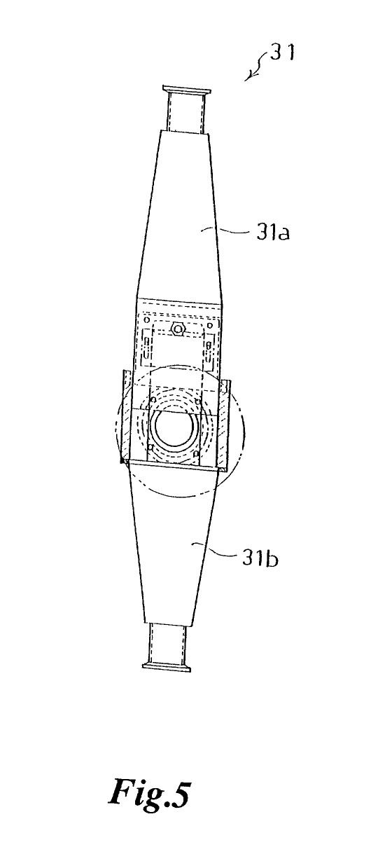

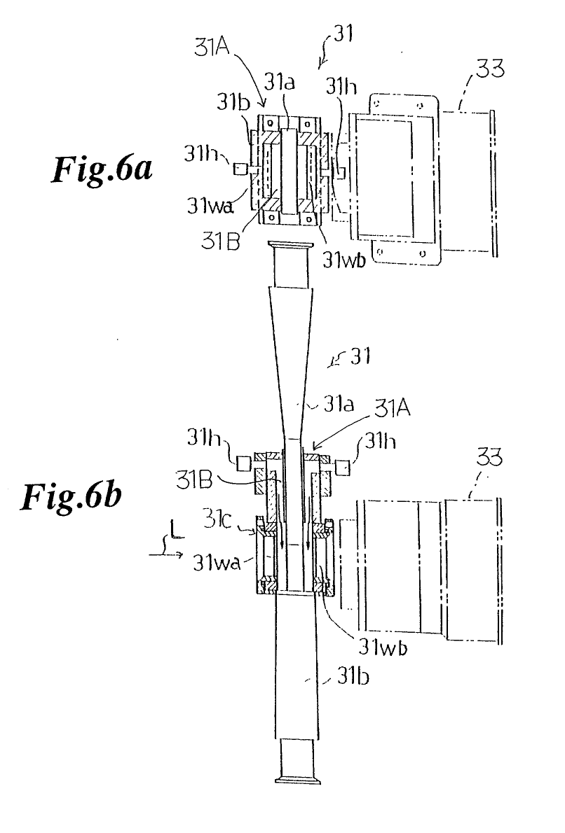

Referring to FIG. 5, FIG. 6a and FIG. 6b, the construction of the measurement cell 31 will be explained in more detail.

The measurement cell 31 is constructed such that a lower part of an upper cell part 31a is inserted in and airtightly jointed to an upper part of a lower cell part 31b so as to form an overlapped part 31A.

The upper cell part 31a has cylindrical body with a tapered upper part and the lower flat part connected thereto and the lower cell part 31b has cylindrical body with a rectangular upper part and a reverse tapered lower part connected thereto.

The measurement cell 31 is formed with a gap defined by both of which outer sides are interposed by a pair of transmission windows 31wa, 31wb, and light projecting means 32 and the light detector 33 are faced interposing the windows 31wa, 31wb. Such light transmission windows 31wa and 31wb may be preferably made of quartz.

According to such construction, when the suction means 40 is operated, a part of groups of growing particles floating in the granulation tank 2 is introduced into the measurement cell 31 defined by the pair of transmission windows 31wa and 31wb and then light beams are applied to the particles from the light projecting means 32 to receive the diffracted and/or scattered light from the particles into the light detector 33. The reference character L shows an optical pass between the light projecting means 32 and the light detector 33.

Further according to such constructed measurement apparatus, since the upper cell part 31a is constructed such that a flat base part is connected to the upper tapered part, and the other lower cell part 31b is constructed such that the reverse tapered lower part is connected to the upper rectangular part and the lower part of the upper cell part 31a is airtightly inserted in the upper part of the lower cell part 31b so as to form the overlapped part 31A.

Therefore, the particles under granulation are prevented from being mixed each other when they pass through the space between the light transmission windows 31wa and 31wb.

As shown in FIG. 6a and FIG. 6b, the measurement cell 31 is formed with compressed air introduction ports 31h and 31h above the light transmission windows 31wa and 31wb respectively and the ports are connected to an air source such as a compressed cylinder (not shown).

Accordingly, a purge gas can be forcibly supplied into the gap 31B formed in the overlapped part 31A between the lower portion of to upper cell part 31a and the top portion of the lower cell part 31b during granulation process. Therefore, a part of groups of the growing particles or dust particles or the like are prevented from adhering to the surfaces of the light transmission windows 31wa and 31wb.

In the above-mentioned embodiment, purge gas supplied from the air source such as a compressor cylinder (not shown) is flown onto each surface of the light transmission windows 31wa and 31wb. However, it should be understood that the embodiment is mere shows about one of the preferred embodiments.

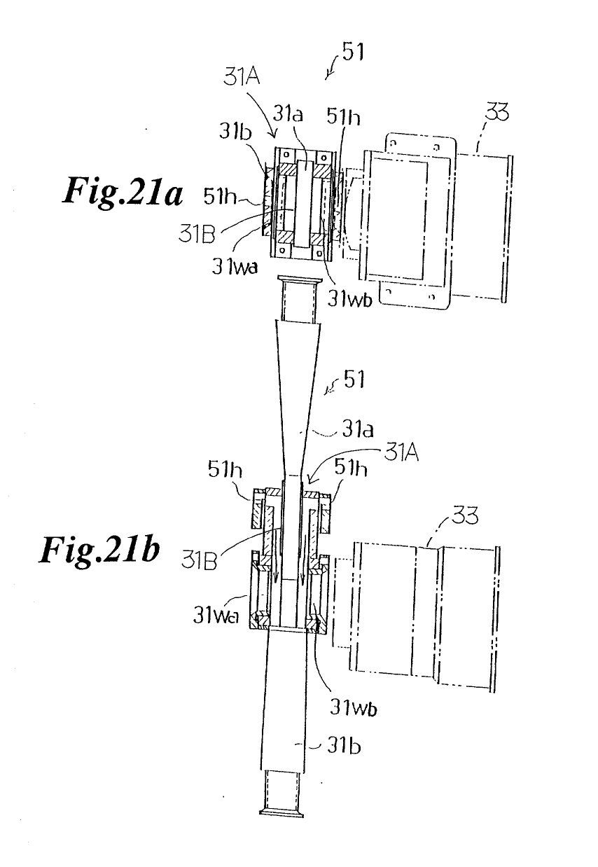

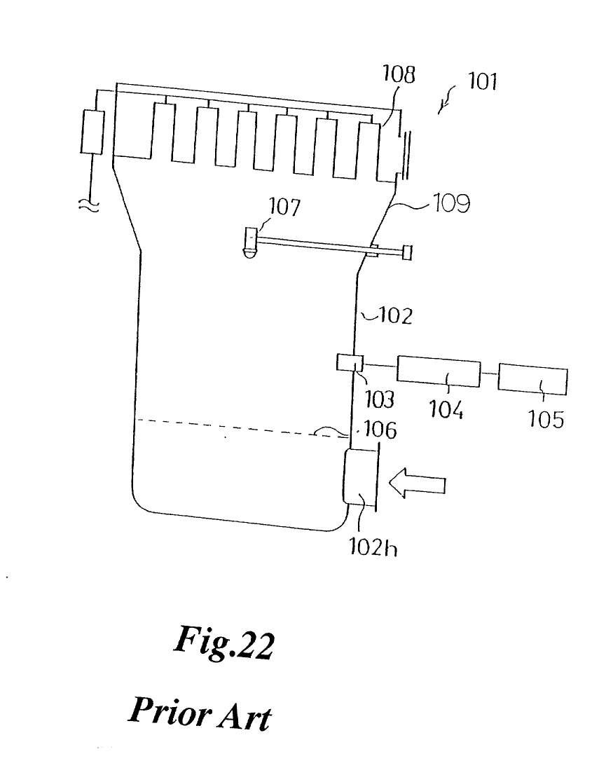

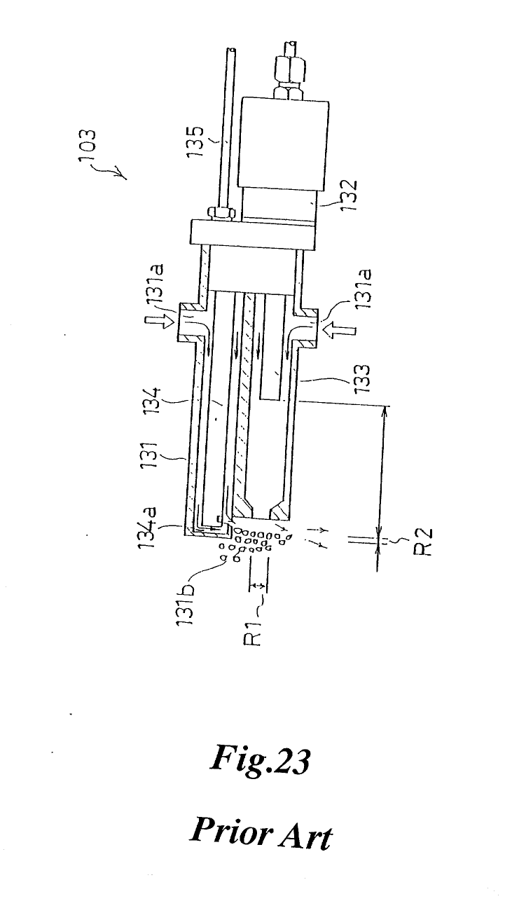

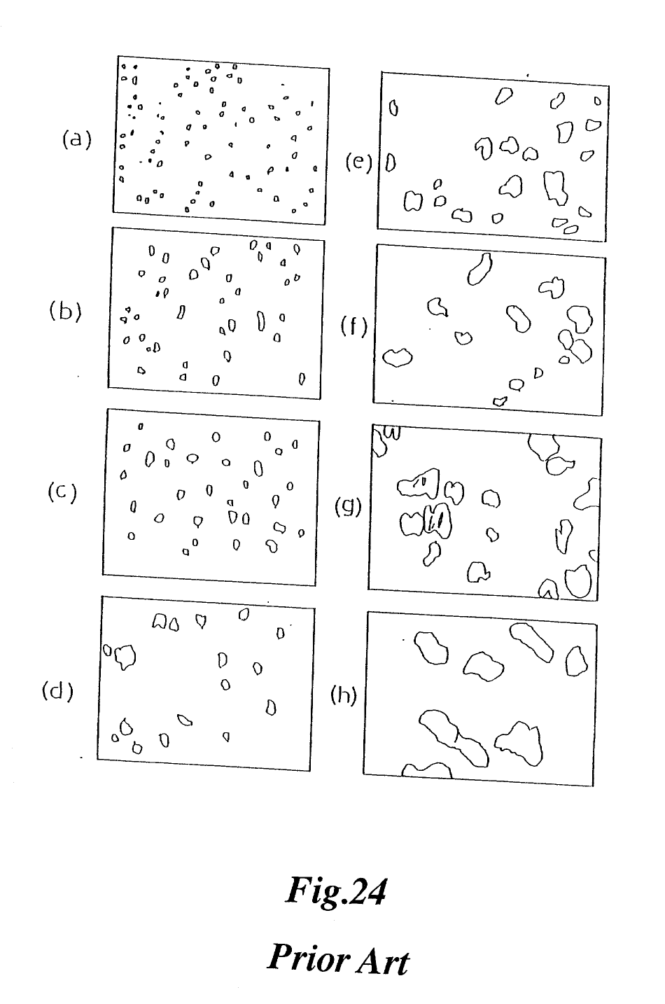

Otherwise, like a measurement cell 51 as shown in FIG. 21a and FIG. 21b, such construction that open air introduction ports 51h and 51h are respectively provided above the light transmission windows 31wa and 31wb and open air enters as purge gas through the ports 51h and 51h to supply onto the surface of one of the transmission windows 31wa and 31wb when the suction means 40 is driven at a fixed revolution speed.

Here the same numerals are used for the same members used in the measurement cell 31 in order to omit their explanations.

In the measurement cell 31, laser beams are emitted at predetermined time intervals and the diffracted and/or scattered light from the particles in the measurement cell 31 is received into and detected by the light detector 33 to be sampled sequentially. The diffracted and/or scattered light thus sampled is further processed and the particle size distribution data is taken into the arithmetic means 39 as a measured data I (Ti) of particle size distribution, ant then is compared with the time-series corresponding objective data D(Ti) of particle size distribution stored in a memory in advance, thereafter necessary correction is added to a basic feedback control which is executed for granulation process in accordance with the result at comparison step, about which it will be explained later.

In case that the present invention is applied to granulation process, a required process time for one batch or its sampling time interval depends on the granulated material to be produced, however, when manufacturing pharmaceutical granulated materials are produced by using granulation tank, one or a few hours will do for one batch process time, and ten minutes or so will do for the sampling time intervals.

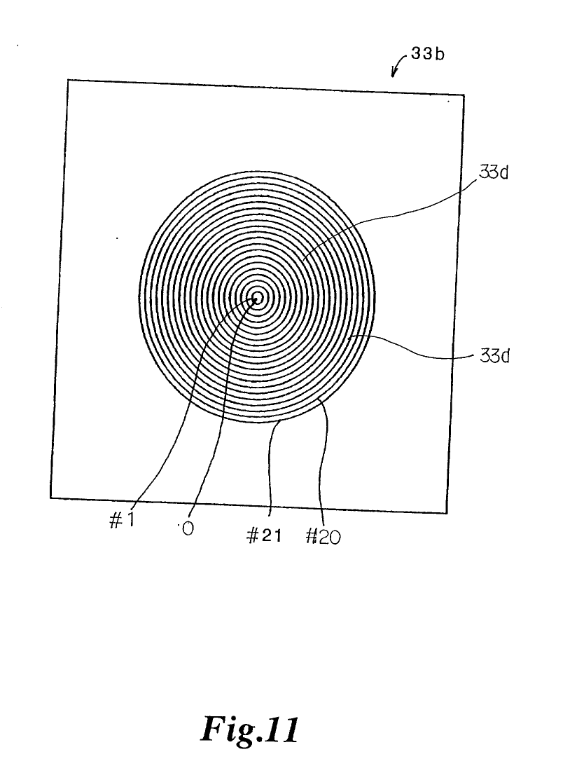

FIG. 11 shows a construction of a ring detector.

The ring detector 33b has concentric 21 ring channels which are disposed equally apart by spacers 33d from the central channel #1 to the outer channel #21.

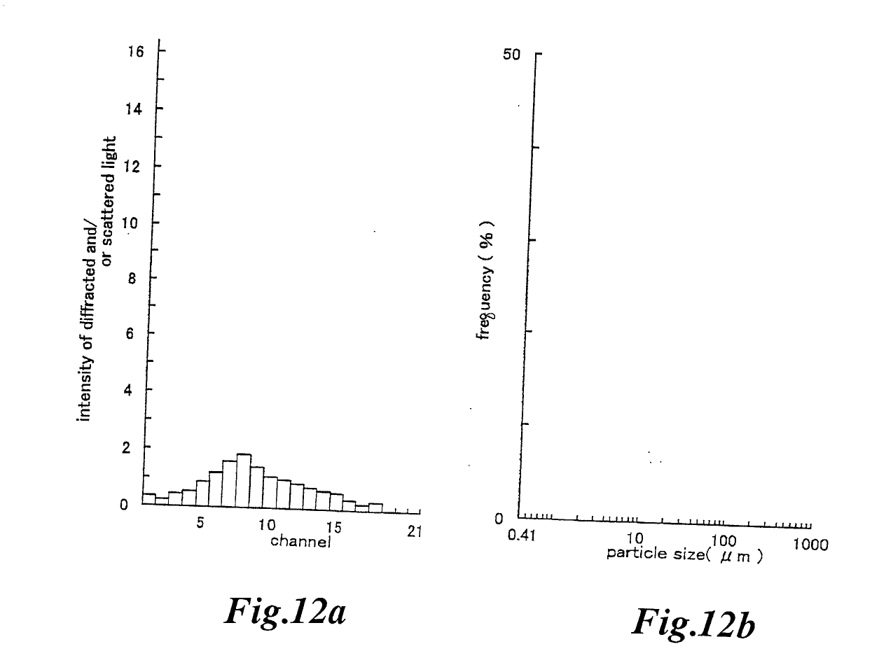

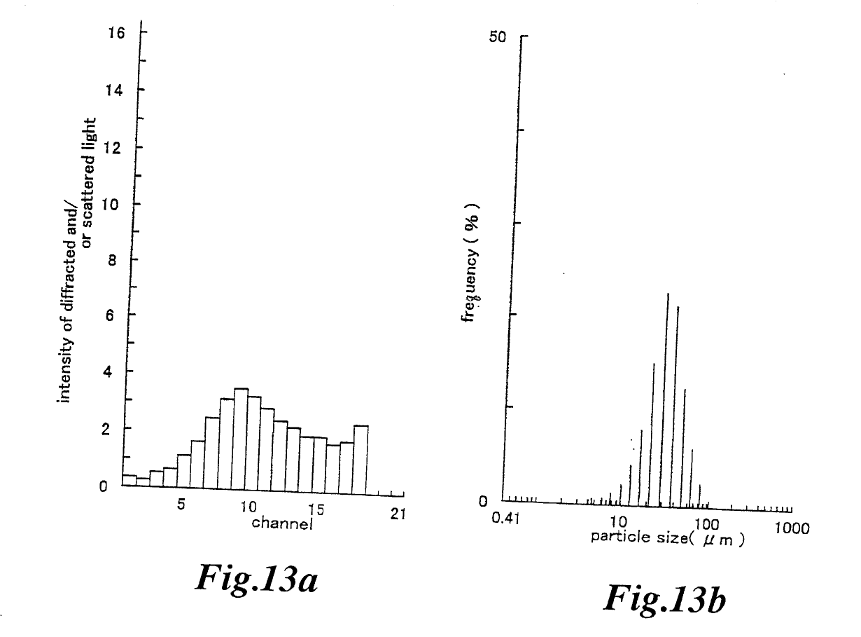

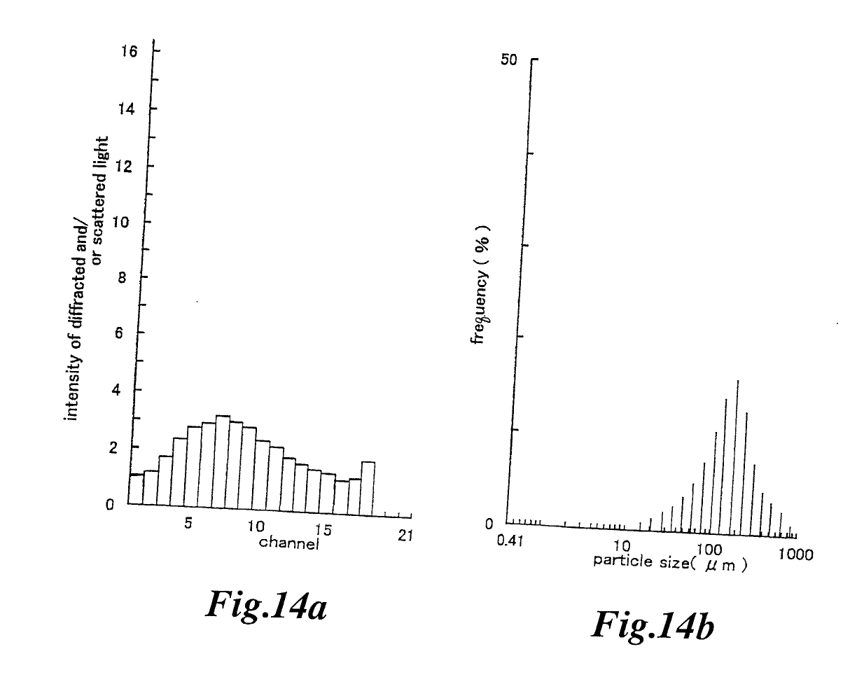

FIG. 12a, FIG. 13a and FIG. 14a show a sampling output appeared on the channels of the ring detector, whereas FIG. 12b, FIG. 13b and FIG. 14b show examples of the particle size distribution data obtained by executing a specified algorism for the sampling output corresponding to FIG. 12a, FIG. 13a and FIG. 14a.

FIG. 12a and FIG. 12b show output values when no raw material are stored in the granulation tank 2. FIG. 13a and FIG. 13b show output values when raw material is charged and is granulated in the granulation tank 2. FIG. 14a and FIG. 14b show output values when the granulation process is finished.

By this way, output (offset output) is appeared on the channels even if there are no objects to be measured i.e. when no raw material are stored so that compensation to remove the offset output is done for the output net value obtained at the time of sampling.

Such a ring detector is supported by the Mie Scatter Theory according which as the particle size gets smaller, the rate of sideward scattering and backward scattering are increased than forward scattering. For such particles with the sizes of larger than or equal to 0.56 μm, the intensity of forward scattering whose scattering angle is small largely changes. Therefore, the particle sizes can be discriminated only by detecting the forward scattering light. However, for such particles with the size of less than or equal to 0.1 μm, the intensity of forward scattering light whose scattering angle is small changes a little and the intensity of sideward scattering and backward scattering largely changes.

As shown inFIG. 12a, FIG. 13a and FIG. 14a, the intensity value appears in a manner that more larger value appears near the center of the ring detector as the particles grow.

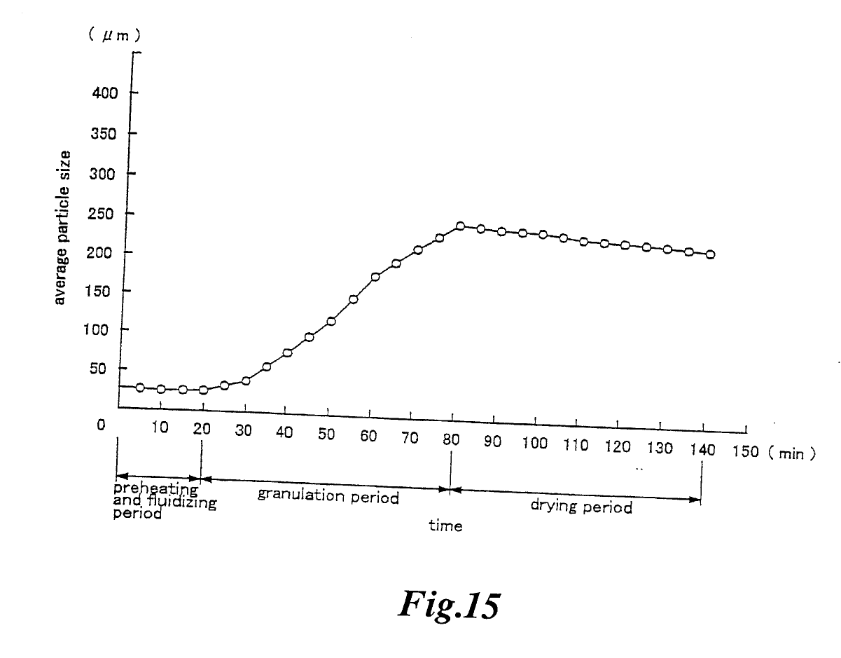

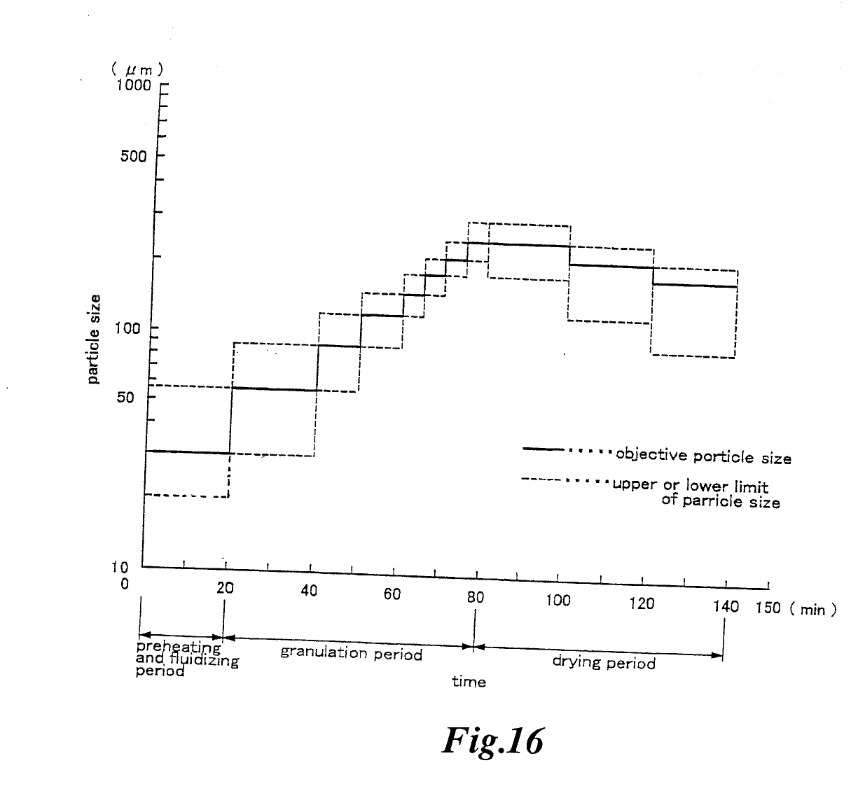

FIG. 15 shows the change of the particle diameter of the particles grown in the granulation tank 2 when materials are granulated therein and FIG. 16 shows the average particle size (shown by solid lines) corresponding to the growing changes of granulated material as shown in FIG. 15 togher with their allowable ranges (shown by dotted lines) with its upper limit value and its lowest value during granulation process. The particles in the granulation tank 2 doesn't grow in a preheating period, gradually grows accompanying spray of a blinder solution to reach the largest value in a granulation period, then is gradually reduced following drying process to grow up to be a desired size in a drying period.

Next, a principle for correcting a basic feedback control for batch granulation process, which is one of characteristics of the present invention, will be discussed.

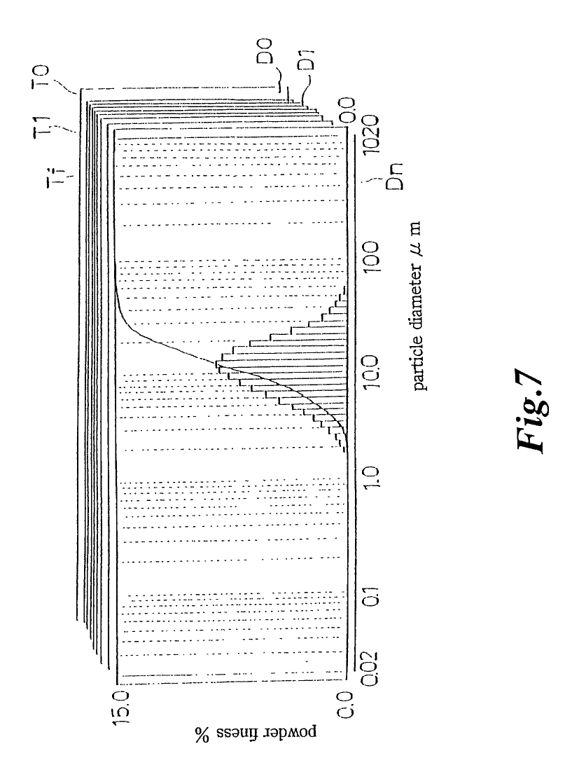

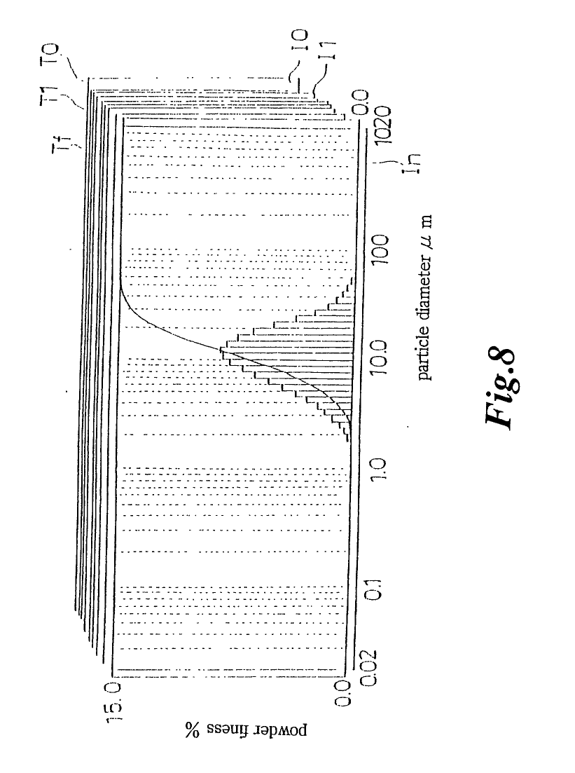

FIG. 7 shows particle size distribution objective data used in the present invention and FIG. 8 shows measured particle size distribution data obtained at sampling step.

The particle size distribution objective data D1, D2, . . . Dn are time series group data obtained by applying beam light to the growing particles in the granulation tank 2 and by sampling at predetermined time intervals T0, T1, . . . Tf from the start to finish of granulation process. In this figure, the objective data is conceptually shown as time series data obtained by applying a specified algorism to actual sampled data of the diffracted and/or scattered light from the growing particles.

The objective data D1, D2, . . . Dn are such group data as selected from successful examples with respect to raw powdered materials of which amount is the same as the raw powdered materials to be granulated, obtained from sampled diffracted and/or scattered light from growing particles while executing a basic feedback control for granulation process.

From view of that point, the objective data is a pilot data used for correcting the basic feedback control. Accordingly, the sampling intervals T0, T1 . . . Tf applied to the objective data D1, D2, . . . Dn is the same as that applied to the measured data I0, I1, . . . In for growing particles to be granulated in the granulation tank 2, in other words the cycle for sampling the diffracted and/or scattered light obtained by applying beam light to the growing particles in the granulation tank 2, is set up the same for the objective data D1, D2, . . . Dn and for the measured data I0, I1, . . . In.

Further at the comparison step of the present invention, the particle sizes φi, φd which are respectively calculated from the measured data I0, I1, . . . In and the objective data D1, D2 . . . Dn, those data is set up same in time series and at comparison step, the measured data I0, I1, . . . In are one by one compared with the corresponding objective data D1, D2 . . . Dn in time series.

Production method of granulated materials will be described according to the granulation system 1.

Raw powdered materials are placed on a fluid bed 6 and a heated air is supplied into the granulation tank 2 through a heated air supply port 2h to fluidize and mix the raw powdered materials with the heated air, a binder solution is sprayed from nozzle means 7 to aggregate the powdered materials floating above the bed 6, then the particles are dried.

In this granulation process, the granulation tank 2 is heated and the particle growing factors are controlled by executing a basic feedback control.

While the granulation process is operated, valves 35 and 36 are opened to drive suction means 40 at a fixed revolution speed.

Then, a part of groups of the growing particles floating in the granulation tank 2 is sucked to be introduced into the measurement cell 31. Laser beams is applied to the measurement cell 31 from the light projection means 32, and the diffracted and/or scattered light from the particles floating in the measurement cell 31 is sampled at fixed time intervals T0, T1, . . . Tf, while executing granulation in the granulation tank 2, thereby obtaining the particle size distribution measurement data I0, I1 . . . In.

In the present invention, each time the particle size distribution measurement data I0, I1 . . . In are obtained, they are compared with the particle size objective data D0, D1 . . . Dn, corresponding in time series, prepared in advance.

At comparison step, the particle diameters φi and φd are calculated respectively from the particle size distribution measurement data I (Ti) and the particle size distribution objective data D (Ti) by the same arithmetic operation.

Then, particle diameters φi, φd thus calculated are compared. At the next correction step, when the particle diameter φi calculated from the sampled particle size distribution measurement data I (Ti) exceeds an allowable range (see FIG. 16) i.e. smaller than the particle diameter φd calculated from the corresponding particle size distribution objective data D (Ti), correction for promoting the particles is further added to the basic feedback control. On the other hand, the particle diameter φi calculated by the sampled particle size distribution measurement data I (Ti) exceeds the allowabla range i.e. larger than the particle diameter φd calculated from the corresponding particle size distribution objective data D (Ti), correction for stopping growing the particles is added to the basic feedback control. When the particle diameter φi calculated from the sampled particle size distribution measurement data I (Ti) agrees with the particle diameter φd calculated from the corresponding particle size distribution objective data D (Ti) within the allowable range, no correction is added to the basic feedback control.

The temperature and flow amount of the heated air and the spray amount of a binder solution are typical as the particles growing factors for adding correction to the basic feedback control.

It is known that the particle sizes of growing materials becomes large fast when the spray amount per time, namely spray amount/time, is increased and that the particle sizes also rapidly becomes large even when the temperature of heated air is lowered.

Further, since the growing speed of the particles under granulation is closely related to the moisture content of the powdered materials, as a rule the growing speed of the particles will become fast, if the amount of heat supplied in the granulation tank 2 is reduced under the condition that the spray amount/time of a binder solution is constant, while the growing speed will become slow if the amount of heat supplied in the granulation tank 2 is increased.

Moreover since the heat quantity supplied into the granulation tank 2 is determined by the temperature and flow amount of the heated air supplied into the granulation tank 2, the moisture content in the granulation tank 2 will become relatively high whereby the growing speed will become fast when the amount of heated air is lowered under the condition that the spray amount/time (spraying speed) and the temperature of the heated air are constant or when the flow amount of heated air is lowered under the condition that the temperature of the heated air is constant. However, the moisture content in the granulation tank 2 will become relatively low whereby the growing speed of the particles will become slow when the temperature of heated air is heightened under the condition the flow amount of the heated air is constant or when the flow amount of heated air is increased under the condition that its temperature is constant.

Accordingly, in adding changes into the basic feedback control the spray amount/time is increased when sampled and analyzed particle size distribution data show that so many small particles are included, while the spray amount/time is decreased when sampled and analyzed particle size distribution data show that so many large particles are included, however the spray amount/time is kept as it is when its particle size distribution data is similar within the tolerance.

According to the present invention, since necessary correction is added to the basic feedback control at predetermined time intervals so as to correct the diviation from the objective particle size distribution data, therefore the granulated materials to be produced are controlled so as to grow the granulated materials up to be particles with desired particle sizes distribution.

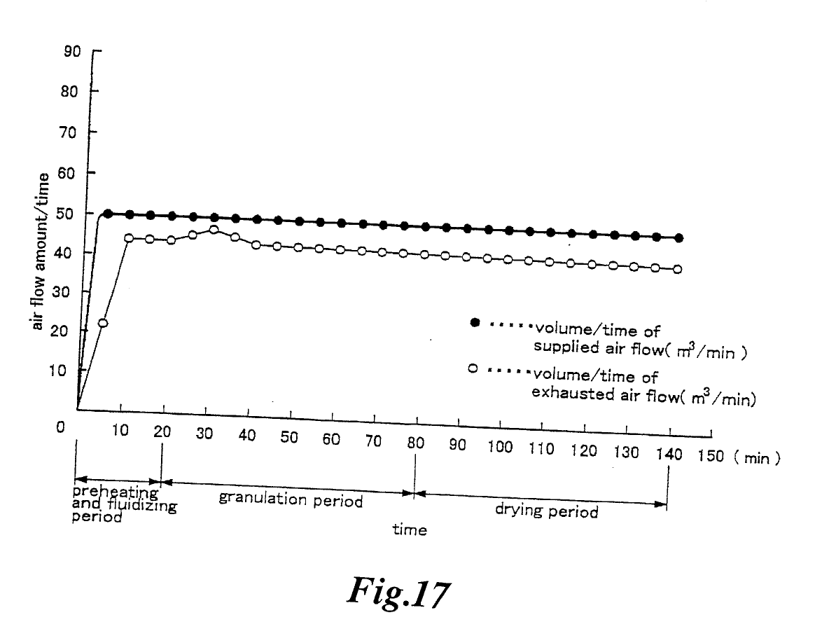

FIG. 17-FIG. 19 show the change in the heated air amount, the binder solution spray amount/time and the heated air temperature supplied into the granulation tank 2 during granulation process, which are also control objects of the basic feedback control in the granulation process.

FIG. 17 shows the amount of heated air supplied into the granulation tank 2 together with the discharge amount from the tank 2. The heated air amount supplied into the granulation tank 2 reaches a predetermined amount at a preheating period, then is kept constant till the end of granulation. Then the discharge amount becomes a little smaller than the supplied heated air amount due to the pressure in the tank 2 is kept at relatively positive than outer air during the granulation process.

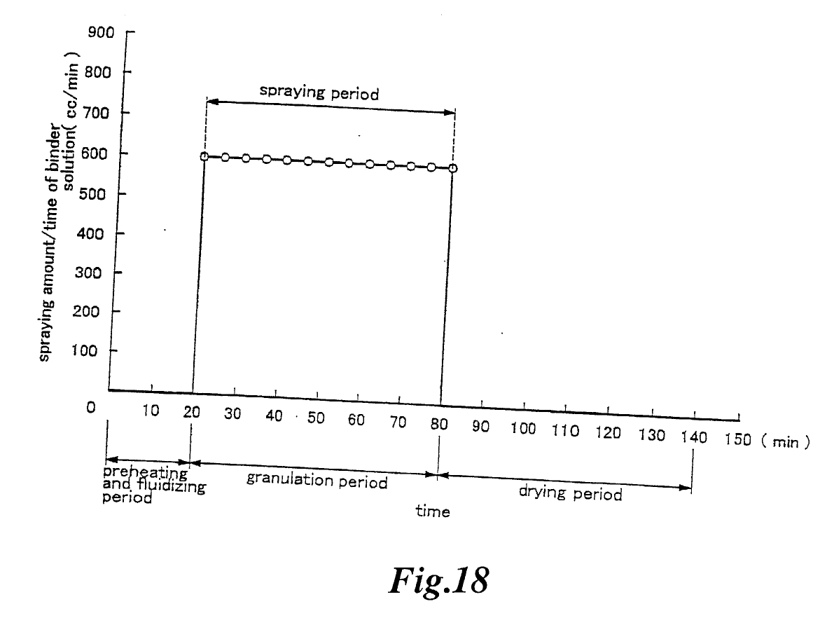

FIG. 18 shows the change in the spray amount of a binder solution. The spray amount is kept constant during the granulation process as shown in FIG. 18.

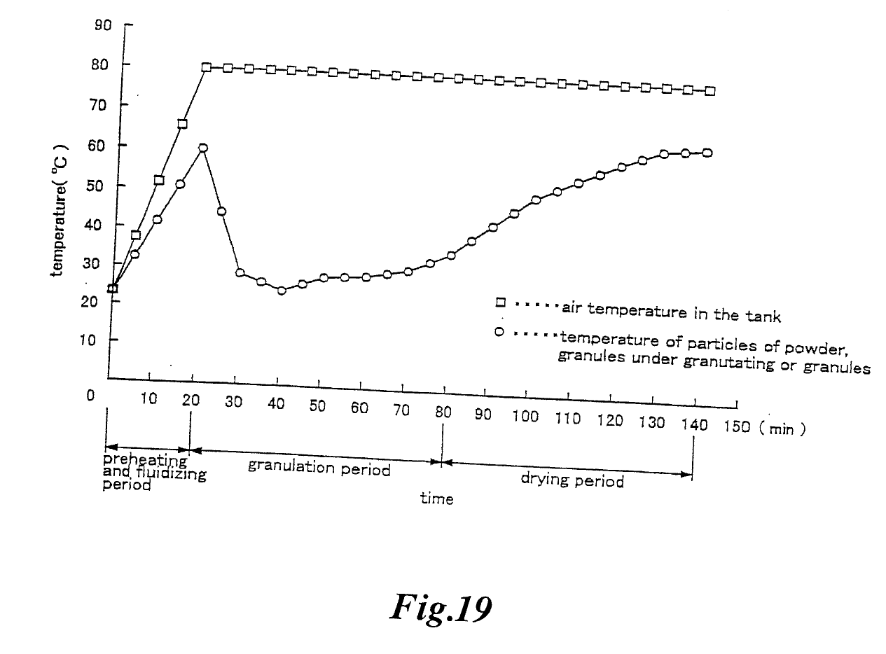

FIG. 19 shows the change in the heated air supplied into the granulation tank 2 together with the temperature of the growing particles their selves in the granulation tank 2. The temperature of the heated air supplied into the granulation tank 2 reaches a predetermined value in a preheating period, then is kept its value constant till the end of the granulation, while the temperature of the growing particles in the granulation tank 2 reaches its peak value at the end of preheating period, then its temperature is suddenly lowered when spraying of a binder solution is started in a granulation period and thereafter its temperature is again gradually increased as the spraying of the binder solution goes.

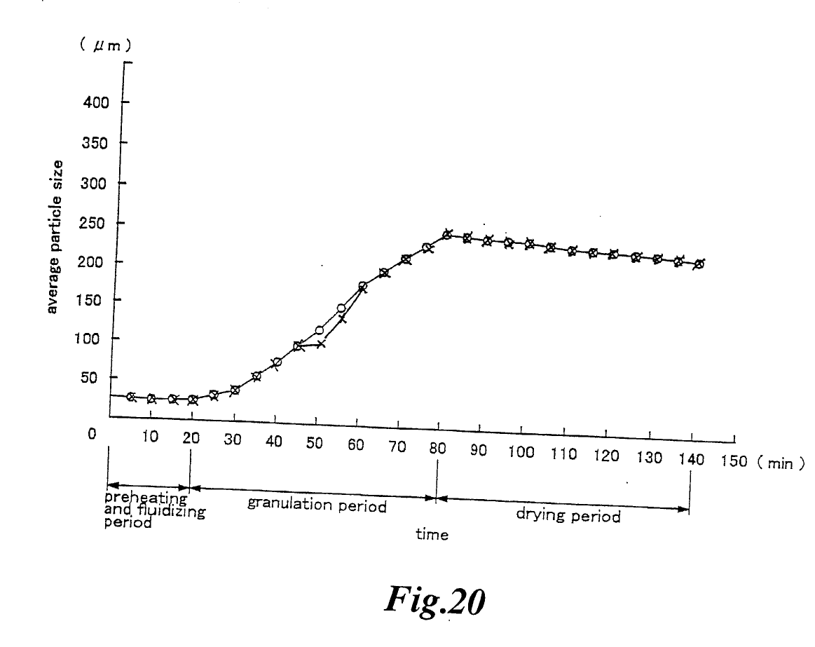

FIG. 20 graphically shows the state that a basic feedback control is corrected by carrying out the present invention, as a result the deviation between the particle diameter (shown by ×) calculated from the sampled particle size distribution measurement data and the particle diameter (shown by ∘) calculated from the corresponding particle size distribution objective data in time series is corrected.

This graph shows that the particle diameter of the growing particles calculated from the data measured obtained in the way of the situation that spraying of the binder solution is progressed during the granulation period becomes a little smaller than the particle size diameter calculated from the objective data during the period and thereafter the particle growing factors such as the heated air flow amount, the heated air flow temperature and the spray amount of a binder solution are controlled by executing the present invention, thereby being added correction to the basic feedback control and finally the particle size of the growing particles to be granulated becomes the same as the particle size of objective data. Therefore it will be noted that the particles with the same diameter as the objective data are appropriately produced by carrying out the present method.

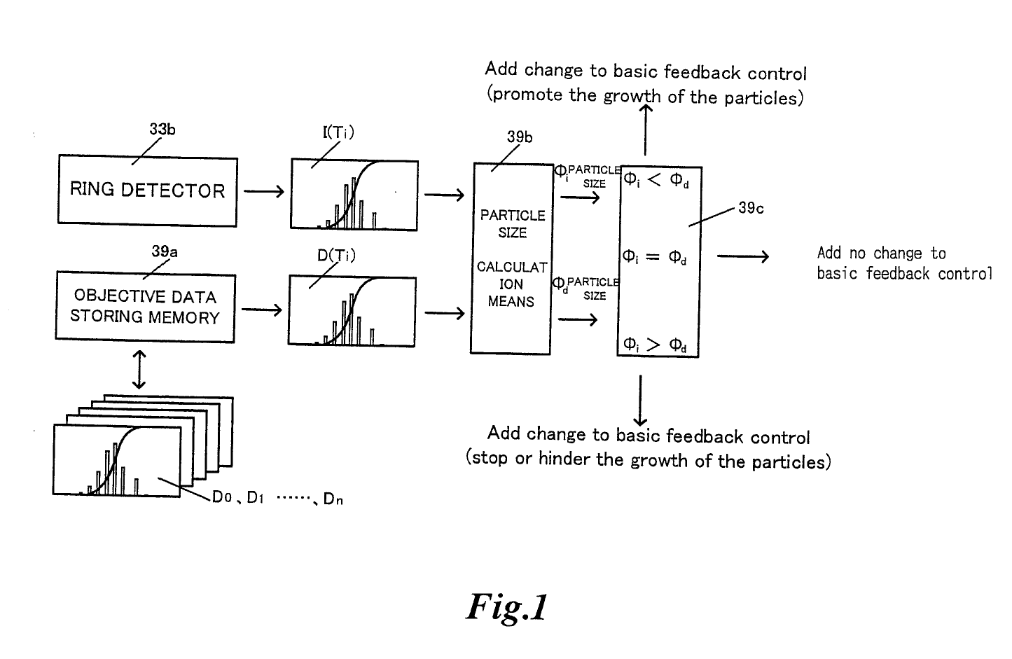

FIG. 1 shows a basic principle of the present invention method.

At a sampling step, the particle size distribution data calculated by applying a specified algorism to the output signals detected by the ring detector 33b and taken in as a particle size distribution measurement data I (Ti).

Then at a comparison step, particle size distribution measurement data I (Ti) thus taken-in is compared with the corresponding particle size distribution objective data D (Ti) in time series stored in the memory 39a in advance. In this comparison, for facilitating arithmetic operations, especially in the sample described here, the particle diameters φi and φd are respectively calculated from particle size distribution measurement data I (Ti) and particle size distribution objective data D (Ti) by the arithmetic means 39b. However, each of corresponding the particle size distribution information their selves may be compared.

If the particle diameter φi calculated from the sampled measurement data I (Ti) exceeds allowable range relative to particle diameter φd calculated from the objective data D (Ti) corresponding in time series, comparison means 39c adds the above-mentioned change to the basic feedback control for granulation process. However, if the diameters φi is within allowable range relative to particle diameter φd calculated from the objective data D (Ti) corresponding in time series, any correction is not added to the basic feedback control, thereby maintaining the basic feedback control as it is.

Next a preferable granulated materials production apparatus as the alternative embodiment will be explained.

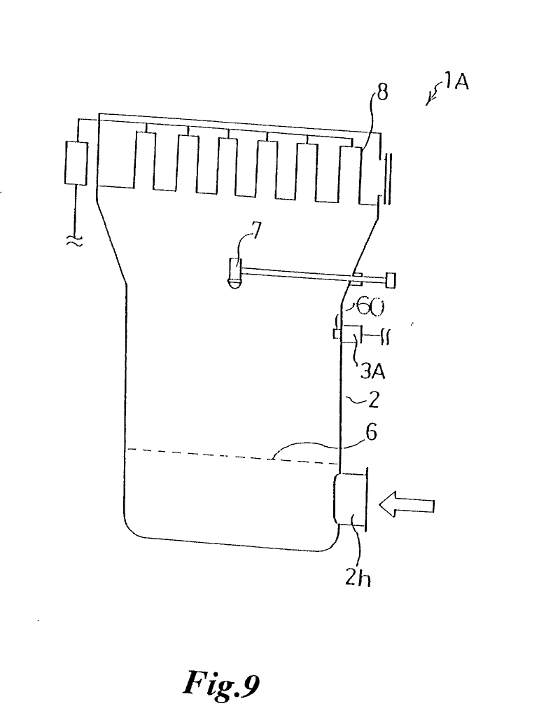

A granulation apparatus 1A, as shown in FIG. 9, has a granulation tank 2 and a measurement probe 3A.

The other construction of the granulation apparatus 1A is the same as the granulation apparatus 1 shown in FIG. 1, so corresponding parts are designated adding the same reference numerals in order to omit their descriptions.

The measurement probe 3A is constructed such that a probe part 60 (measurement part, hereinafter referred as probe) can be directly inserted into a corresponding portion of the granulation tank 2.

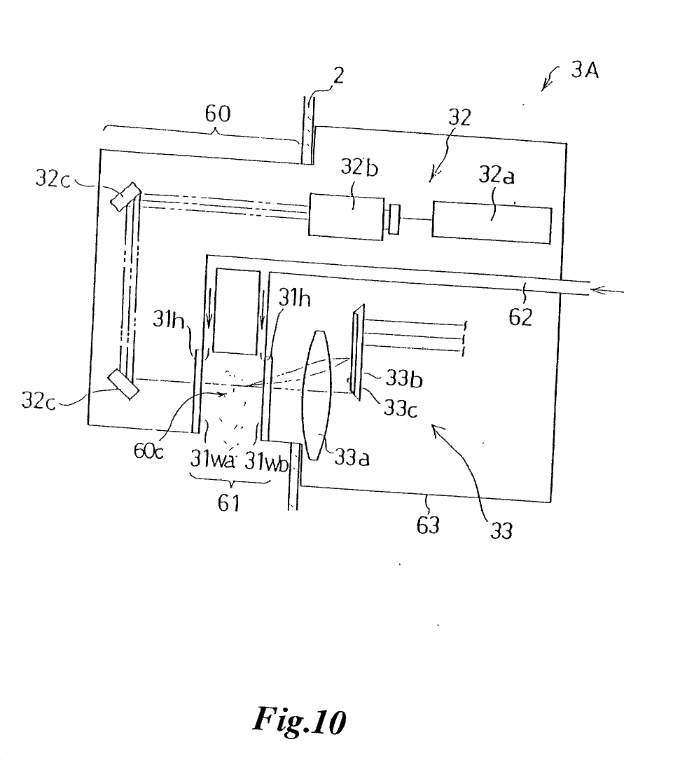

FIG. 10 is a cross sectional view showing a basic construction of the measurement probe 3A. The probe 60 has a concave 60c and is provided with light transmission windows 31wa and 31wb facing each other which constitute measurement chamber 61.

Therefore, the measurement chamber 61 is defined by a space interposed with the light transmission windows 31wa and 31wb, on both their outward sides a light projection means 32 and a light detector 33 are respectively provided.

The light transmission windows 31wa and 31wb may be preferably made of quartz.

Purge gas (shown as an arrow↓ in FIG. 10) is designed to be supplied into the measurement chamber 61, namely flown onto the surfaces of both windows 31wa and 31wb.

More concretely, the measurement chamber 61 is provided with compressed air introduction ports 31h and 31h around the light transmission windows 31wa and 31wb respectively and are connected to an air source such as a compressed cylinder (not shown) via a pipe 62. Hence compressed air is flown into the measurement chamber 31 as purge gas through the pipe 62 when compressed air is introduced into the pipe 62, thereby causing the purge gas to flow onto the surfaces of the light transmission windows 31wa and 31wb preventing adhering of dust particles or growing particles under granulation to the surfaces of the windows.

The other constructions of the measurement probe 3A are the same as that of the sample measurement apparatus 3, the same reference numerals are added to the corresponding members in order to omit their explanations.

According to this apparatus, while operating the granulation tank 2, namely under granulation process, purge gas is flown onto the surfaces of the light transmission windows 31wa and 31wb of the measurement chamber 61 so as to prevent adhesion of dust or growing particles thereto. Under such condition, laser beams are applied to the measurement chamber 61 from the light projection means 32 at predetermined time intervals and the diffracted and/or scattered light from the particles which naturally enter the measurement chamber 61 is detected by the light detector 33 to be sampled and is taken in the arithmetic means 39 as measurement data.

After the measured data is taken in, it is compared with the objective data prepared corresponding in time series in advance, as mentioned above, and materials are granulated by further controlling the growing factors of the basic feedback control depending on the comparison result.

According to such apparatus, the same effect as the granulation apparatus mentioned above can be obtained and further following effects are expected.

Moreover, accessory equipment such as suction means and pipes isn't required because light beams are applied to the growing particles under granulation in the tank 2 and measurement data are sampled by only inserting the probe 60 into a corresponding portion of the granulation tank 2. Accordingly, the apparatus is simplified in construction and in space saving.

In the above-mentioned embodiment, particle sizes respectively calculated from the measured and the objective data are used, however the present invention is carried out by using particle size distributions of the measured and the objective data their selves are of course used.

1. A production method for producing granulated materials from raw powdered materials by way of batch process, while executing a predetermined basic feedback control of particle growing factor such as temperature of heated air, flow amount of heated air, or injection amount of a binder solution, in which raw powdered materials are fluidized in granulation tank by being mixed with heated air and aggregated each other by being spraying a binder solution then dried,
the method comprising the steps of:
sampling at predetermined time intervals diffracted and/or scattered light from growing particles under granulation in said granulation tank by applying beam light to said growing particles to take out them as measured particle size distribution data,
calculating the size of particle from said measured particle size distribution data by applying a specified algorithm, comparing said size of particle calculated from said measured particle size distribution data with the size of particle calculated from particle size distribution objective data prepared in advance, and
correcting said basic feedback control by controlling said particle growing factor such as temperature of heated air, flow amount of heated air, or injection amount of a binder solution in accordance with the result at said comparison step,
wherein said particle size distribution objective data are defined as time series data of measured particle size distribution data obtained in advance by sampling said diffracted and/or scattered light from growing particles under granulation in said granulation tank by applying beam light to said growing particles, the sampling time interval for said particle size distribution objective data being the same as that for said measured particle size distribution data at said sampling step and the amount of the raw materials for said particle size distribution objective data being the same as that for said raw materials to be granulated in said granulation tank,
wherein at said comparison step, the size of particle calculated from said measured particle size distribution data is compared with that calculated from corresponding particle size distribution objective data in time series, and wherein at said correction step, said basic feedback control is corrected by controlling said particle growing factor so as to promote the growth of said particles in said granulation tank when said size of particle calculated from said measured particle size distribution data is smaller than that calculated from corresponding particle size distribution objective data in time series, whereas said basic feedback control is corrected by controlling said particle growing factor so as to stop or hinder the growth of said particles in said granulation tank when said size of particle calculated from said measured particle size distribution data is larger than that calculated from corresponding particle size distribution objective data in time series.

2. The production method for producing granulated materials as set forth in claim 1, wherein said sampling step is executed in a sampling measurement apparatus communicating to said granulation tank through an introduction conduit, where a part of groups of said growing particles under granulation in said granulation tank is introduced by suction and beam light is applied thereto by a light projection means from one direction and diffracted and/or scattered light from said growing particles is received in to a light detection means provided opposite to said a light projection means.

3. The production method for producing granulated materials as set forth in claim 1, wherein said sampling step is executed in a sampling measurement probe with measurement chamber attached to corresponding portion of said granulation tank, where a part of groups of said growing particles under granulation, floating in said granulation tank, is entering said measurement chamber interposed by a light projection means and a light detection means and beam light is applied to said growing particles by said light projection means and diffracted and/or scattered light from said growing particles is received into said light detection means.

4. The production method for producing granulated materials as set forth in claim 1, 2 or 3, wherein at said calculation step the averages diameter of the growing particles are respectively calculated from said measured particle size distribution data and said particle size distribution objective data.

5. The production method for producing granulated materials as set forth in claim 1, 2 or 3, wherein at said calculation step the median diameter, or 80% diameter of the growing particles are respectively calculated from said measured particle size distribution data and said particle size distribution objective data.

6. The production method for producing granulated materials as set forth in claim 1, 2 or 3, wherein at said calculation step the peak value of the diameter of the growing particles are respectively calculated from said measured particle size distribution data and said particle size distribution objective data.

7. The production method for producing granulated materials as set forth in claim 1, 2 or 3, wherein at said sampling step a laser beam is emitted from a light projection means.

8. A granulated materials production apparatus for producing granulated materials, comprising therein a granulation tank having a fluid bed and spraying means provided above said fluid bed for spraying a binder solution, and a sampling measurement apparatus detachable to said granulation tank,
wherein said sampling measurement apparatus comprises;
a introduction conduit detachable to corresponding portion of said granulation tank,
a measurement cell provided midway of said conduit, and
a suction means provided for introducing by suction a part of groups of said growing particles under granulation in the granulation tank into said measurement cell, and
wherein said measurement cell comprises;
a pair of light transmission windows disposed with a fixed spacing,
a light projection means disposed in one side relative to said pair of light transmission windows, and
a light detection means disposed opposite to said light projection means,
whereby said growing particles in said granulation tank is introduced by suction into said measurement cell by driving said suction means during said granulation tank is operated for performing granulation process and beam light is applied to said growing particles under granulation from said light projection means and diffraction and/or scattered light from said growing particles is received into said light detection means.

9. The granulated materials production apparatus for producing granulated materials as set forth in claim 8, wherein purge gas is forcedly flown onto each surface of said light transmission windows of said sampling measurement cell to prevent growing particles under granulation and/or dust particles from adhering to surfaces of said light transmission windows.

10. The granulated materials production apparatus for producing granulated materials as set forth in claim 8, wherein said sampling measurement apparatus comprises a upper cell part and a lower cell part, each having light transmission portions, and the end portion of said upper cell part is inserted into said lower cell part so as to form an overlapped portion, and wherein purge gas is forcedly introduced into the gap between said upper cell portion and lower cell portion for preventing of adhering of said growing particles under granulation and/or dust particles.

11. The granulated materials production apparatus for producing granulated materials, comprising a granulation tank having therein a fluid bed and spraying means provided above said fluid bed for spraying a binder solution, and a sampling measurement probe detachable to the corresponding portion of said granulation tank,
wherein said sampling measurement probe comprises;
a measurement chamber surrounded by light transmission windows,
a light projection means disposed through said light transmission windows in one side relative to said measurement chamber, and
a light detection means disposed opposite to said light projection means,
whereby a part of groups of said growing particles in said granulation tank enters said measurement chamber during said granulation tank is operated for performing granulation process and beam light is applied to said growing particles under granulation from said light projection means and diffraction and/or scattered light from said growing particles is received into said light detection means.

12. The granulated materials production apparatus for producing granulated materials as set forth in claim 11, wherein purge gas is forcedly flown onto each surface of said light transmission windows of said sampling measurement cell to prevent growing particles under granulation and/or dust particles from adhering to the surfaces of said light transmission windows.

13. The granulated materials production apparatus for producing granulated materials as set forth in any one of claims 8 to 12, wherein laser beam is emitted from said light projection means.
